(19) United States
(12) Patent Application Publication
(10) Pub. No.: US 2006/0085127 A1
(43) Pub. Date: Apr. 20, 2006

(54) Real-time information collection supervising and allocating system and method for vehicle

(75) Inventor: Bo LANG, Shenzhen (CN)

Correspondence Address: BO LANG, 1401 HUATONG BUILDING, SUNGAG EAST ROAD, SHENZHEN, GD 518008, CN

(73) Assignee: Mr. Bo LANG, Shenzhen (CN)

(21) Appl. No.: 10/711,935

(22) Filed: Oct. 14, 2004

(51) Int. Cl. G01C 21/28

(52) U.S. Cl. 701/213

(57) ABSTRACT

A real-time information collection supervising and allocating system and method for vehicle, wherein the identification, fare etc information on the contact and/or contactless IC card being used on vehicle will be read and written by the IC card reader. Signal converter will convert it into digital or non-digital signal. Together with (or without) the video and/or audio signal caught by camera(s) being installed on the vehicle, plus the location information collected by GPS system, via information & data reception and transmission device, being sent to computer(s) in the information center through 3G or other wireless telecom network. The information center will transmit audio, video and/or text instructions to the drivers to allocate the vehicle. Who, where, when, what etc information concerning vehicle are thus being collected. The audio and/or video information can be recorded and tracked in the end of the information center or through internet or intranet. It will bring good effect on transportation resource deploying, anti-theft and anti-terrorism, criminal hunting, battling etc fields.

### TECHNICAL FIELD

This invention relates to a real-time information collection supervising and allocating system and method for vehicle.

### BACKGROUND ART

According to the prior arts, vehicle is equipped with GPS technology for navigation purpose. GPS only solves the problem “where” the vehicle is located. But it does not solve the who, when and what etc problems to provide sufficient information for an efficient vehicle supervising, allocating and deploying.

A system has been proposed wherein navigation data is updated with detected changes in motion including turns, e.g., as disclosed in U.S. Pat. No. 6,633,814. However, this system merely provides more precise positioning means.

Nowadays in many cities, IC cards and card readers are being applied on vehicles especially on public transportation equipment. Some are for the fare charging purpose. Some are to calculate & control the authorization of the riders. But the information of the cards and the card-holders is far beyond being in full usage, i.e., the card being read once means one person is on board of the vehicle. Twice means two persons. The rest may be deduced by analogy. The information on the numbers of people on board can be collected and sent to the traffic control center for a better purpose.

### SUMMARY OF THE INVENTION

It is therefore an object of this invention to provide a real-time information collection supervising and allocating system and method for vehicle to equip the information center with real-time information on vehicle in order to supervise and allocate the vehicle.

The present invention in one embodiment provides a real-time information collection supervising and allocating system, comprising a wireless telecom network, wherein the system also includes a contact and/or contactless IC card and card reader & writer on vehicle. It can also include a signal converter, information and data reception and transmission device, computer servers in the information center. The said signal converter is used to convert the information read by IC card reader and writer into digital or non-digital signal. The said information and data reception and transmission device is used to transmit the above-mentioned digital or non-digital signals to the computer servers in the information center via wireless telecom network and being recorded into memory device.

In a further embodiment of the present invention, the system also includes CCTV monitoring equipment to collect video and/or audio signals on the spot inside of the vehicle. The video and/or audio signals will be transmitted to the computer servers in the information center via the information and data reception and transmission device through wireless telecom network and being recorded into memory device.

The information center also has allocating information transmission device to transmit audio, video and/or text instructions to drivers through wireless telecom network to allocate the vehicle.

The present invention also includes a method comprising the steps of transmitting information via wireless telecom network, wherein identification and fare etc information inside of the contact or contactless IC card in the vehicle end, are read and written by IC card reader & writer. Signal containing above-mentioned information is converted by signal converter into digital or non-digital signal. The information and data reception and transmission device will transmit the above-mentioned digital or non-digital signals to the computer servers in the information center via wireless telecom network and being recorded into memory device.

In a further embodiment of the present invention, the method comprising the steps of collecting video and/or audio information by CCTV monitoring equipment and then transmitting it to the computer servers in the information center via the information & data reception & transmission device through wireless telecom network and being recorded into memory device.

The information center will transmit audio, video and/or text instructions to the drivers to allocate the vehicle through 3G or other wireless telecom network.

As a result, the information center can thus conveniently and accurately collect who, when and what etc information on the vehicle besides of the “where” information. It's much easier to supervise and allocate the vehicle. It will bring good effect on transportation resource deploying, anti-theft and anti-terrorism, criminal hunting, battling etc fields.

### BRIEF DESCRIPTION OF THE DRAWINGS

FIG. 1 Shows the first embodiment of the present invention.

FIG. 2 Shows the second embodiment of the present invention.

FIG. 3 Shows the third embodiment of the present invention.

FIG. 4 Shows the forth embodiment of the present invention.

FIG. 5 Shows the fifth embodiment of the present invention.

FIG. 6 Shows the sixth embodiment of the present invention.

FIG. 7 Shows the seventh embodiment of the present invention.

FIG. 8 Shows the eighth embodiment of the present invention.

FIG. 9 Shows the ninth embodiment of the present invention.

### DETAILED DESCRIPTION OF THE DRAWINGS

This invention will now be described in further details with reference to the drawings.

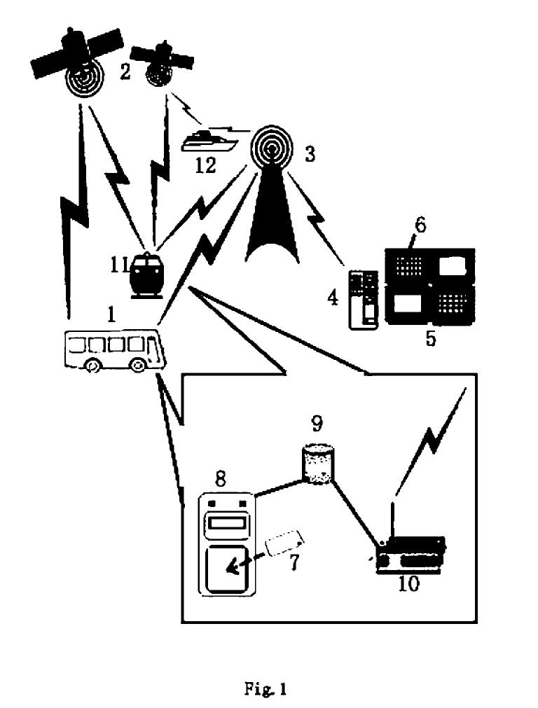

Fig.1 shows one embodiment of the present invention providing the identification, fare etc information on the contact or contactless IC card 7 on the side of the vehicle 1, including but not limited to public transportation vehicle, private transportation vehicle, finance security transportation motorcade for banks, commercial transportation motorcade, police patrol motorcade, military vehicle, which will be described in further details in later embodiments, is read and written by IC card reader and writer 8. The signal converter 9 will convert it into digital or non-digital signal. The information and data reception and transmission device 10 will transmit the above-mentioned information to the computer servers 4 in the information center via wireless telecom network 3, including but not limited to mobile telecom network, radio telecom network, TV microwave telecom etc network, and display them on the display screen 5, including but not limited to screen wall, in the meantime record them into memory device for future use.

The information center also has allocating information transmission device to transmit audio, video and/or text instructions to drivers through wireless telecom network to allocate the vehicle.

The current one and only positioning information of the vehicle 1, is obtained via GPS—Global Positioning System being embedded in the information and data reception and transmission device 1 0 via satellite 2 and being transmitted to the computer server 4 in the information center via wireless telecom network 3 and being displayed on the electronic maps 6 on the display screen 5.

IC card reader & writer 8, signal converter 9 and information and data reception and transmission device 10 can be separated device or integrated into one unit.

Along with the wide application of electronic currency with IC card as the carrier, virtual currency will replace substantial currency. If the IC card is input with banking info, it will have the function of credit card. If it's input with identification information of the user, it will have the function of intelligent ID card. In the meantime of providing positioning information of vehicle, especially buses, ferries 12, trains 11 etc public transportation vehicle, via GPS system, when people using IC card 7, this system will send charging amount, number of users, time, the identification of the users etc additional inside information of the vehicle to the information center through wireless telecom network. This will be convenient for the information center to increase or decrease the transportation force in real-time according to these information and to control the operational speed of the vehicle in real-time etc to maximize the operational benefit. If this system covers buses, ferries 12, trains 11 etc all public transportation vehicle within certain region or in the whole state scope, and the charging system is completely replaced by general IC cards, then once any targeted users appear in any public transportation vehicle, his/her current dynamic position can be transmitted to the information center in real-time. When this system being applied in public security field, it will have anti-theft, anti-terrorism, criminal hunting etc functions.

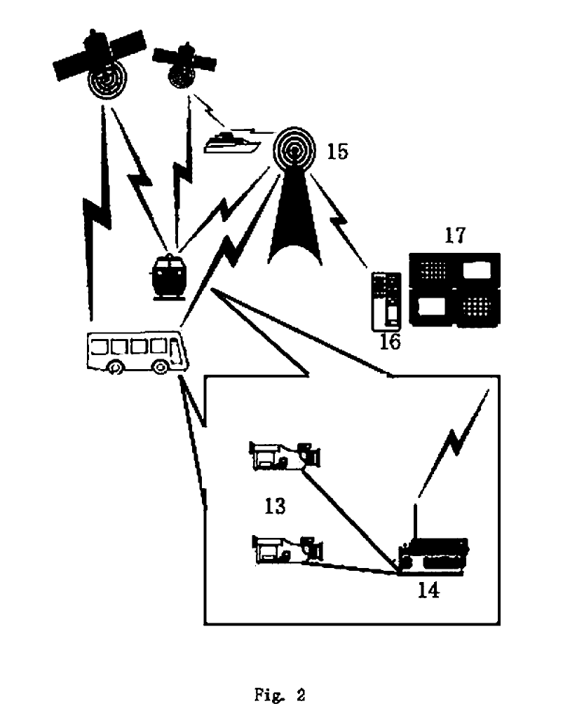

FIG. 2 shows another embodiment of the present invention. The audio & video signals being collected by the cameras etc units of the CCTV monitoring equipment 13 are sent to the computer servers 16 in the information center via the information & data reception & transmission device 14 through wireless telecom network 15, including but not limited to 3G mobile telecom network, network that applying Bluetooth technology, TV microwave telecom and other wireless video & audio transmission technologies, and displayed on the display screen 17 or recorded into memory devices for future tracking.

The information center can thus observe the inside information in real-time in one or multiple route(s) of vehicle.

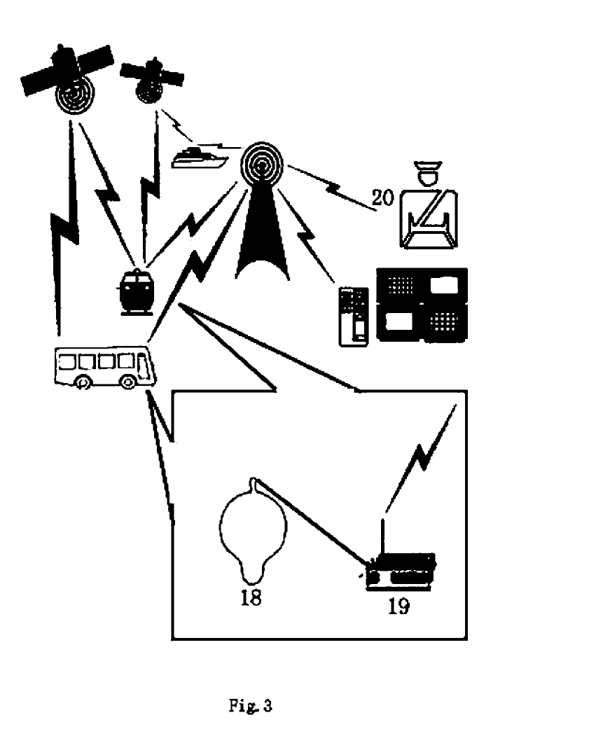

FIG. 3 shows the third embodiment of the present invention. Set up manual or foot-operated alarm device 18 near the driver. When theft, highjack, traffic accident etc emergency situation occurs, the driver may quietly touch the manual or foot-operated alarm device 18 to send the alarm information to the information center via the information & data reception & transmission device 19, in the meantime to send the alarm information to the police station 20.

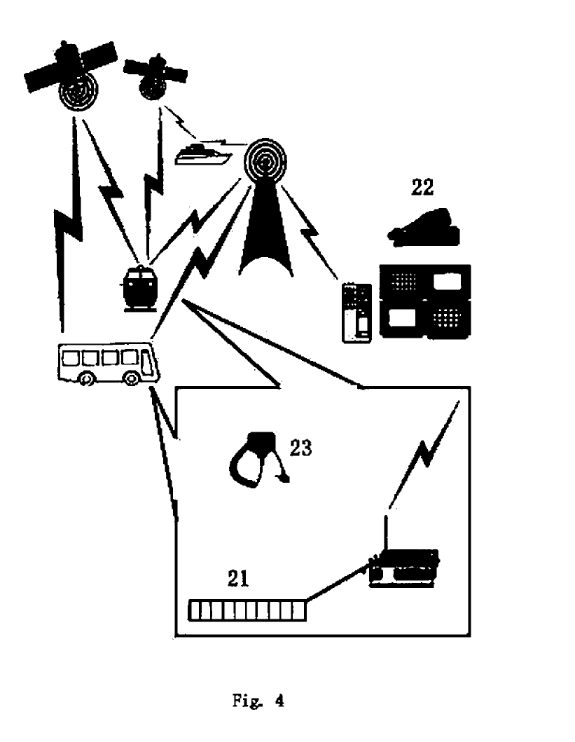

FIG. 4 shows the fourth embodiment of the present invention. Set up speaker and text or video display screen 21 or wireless VHF phones 22 and 23 near the driver. The information center may transmit audio, video and/or text etc instructions to drivers via the speaker and text or video display screen 21 and wireless telecom network, or separately transmit audio information via VHF phones 22 and 23, to allocate the vehicle.

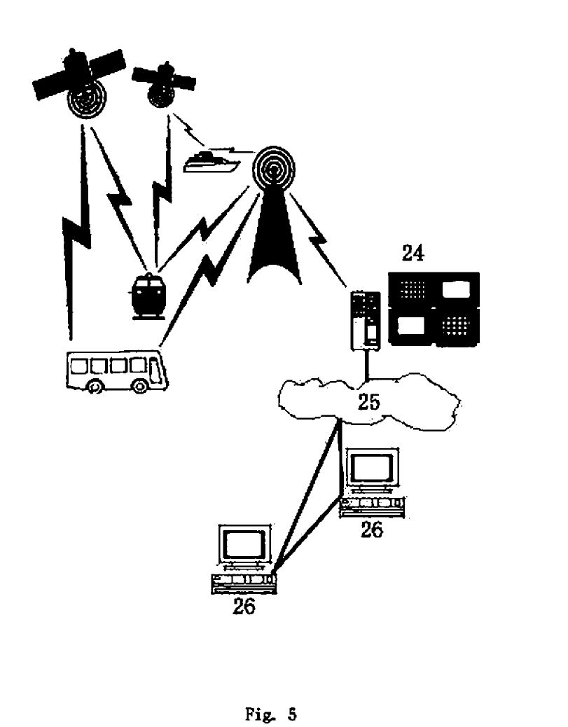

FIG. 5 shows the fifth embodiment of the present invention. The information center is linked with intranet 24 or internet 25. The authorized users 26 may enter into this system in any time any place to browse the dynamic real-time audio, video and/or text information of the vehicle by using software based on intranet 24 or internet 25.

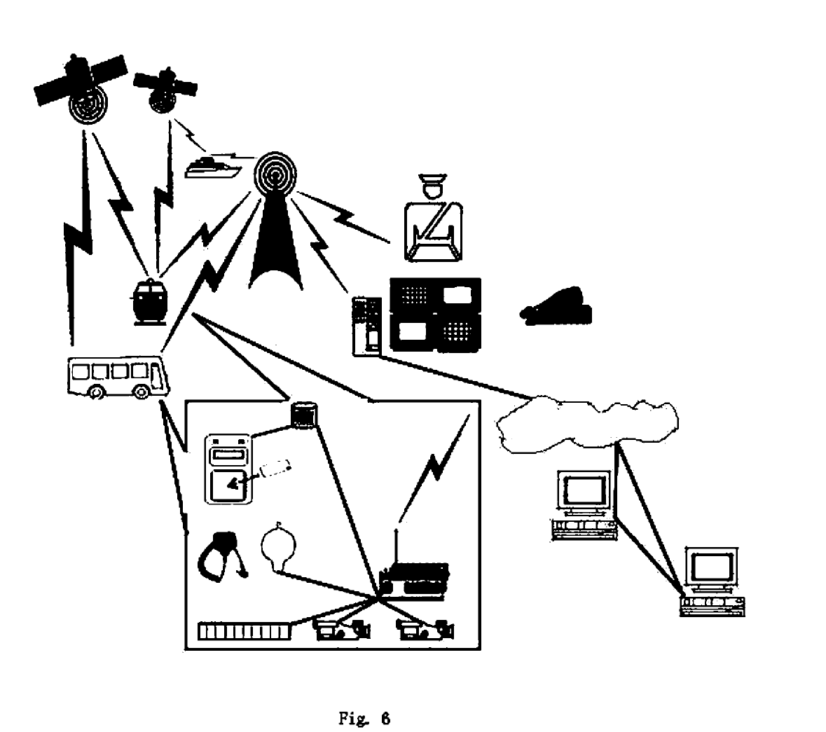

FIG. 6 shows the sixth embodiment of the present invention. It's a combination of above-mentioned embodiments.

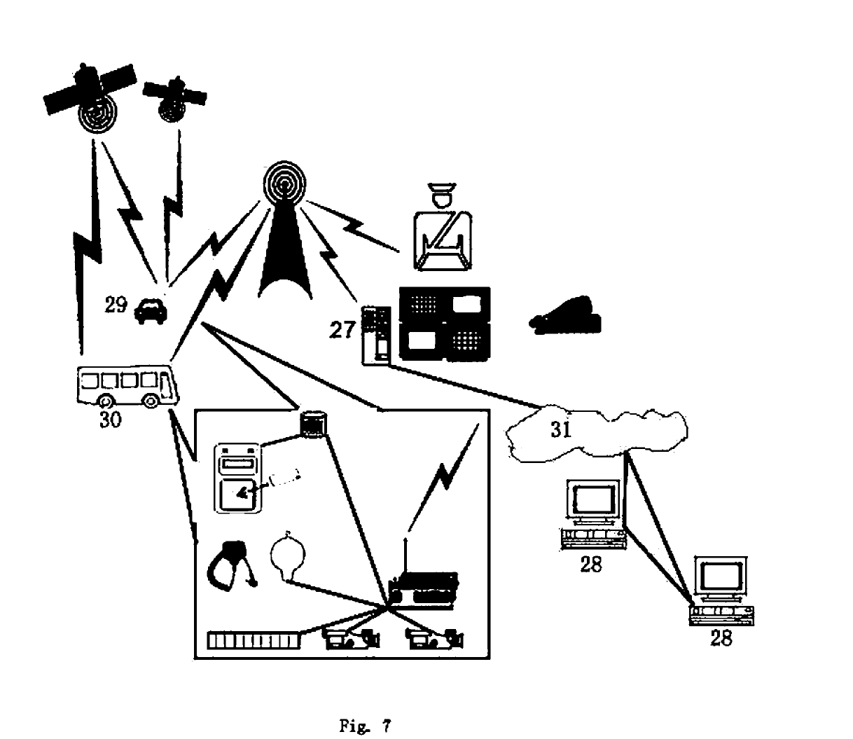

FIG. 7 shows the seventh embodiment of the present invention. The information center 27 of the system may be operated as an independent platform. When being used on a private car 29 or school bus 30 for an individual user 28, children or other person who use IC card when getting on the vehicle will allow the individual user 28 to know whether children or other person are inside of the target vehicle and other real-time audio, video and current position etc information through internet in any time any place.

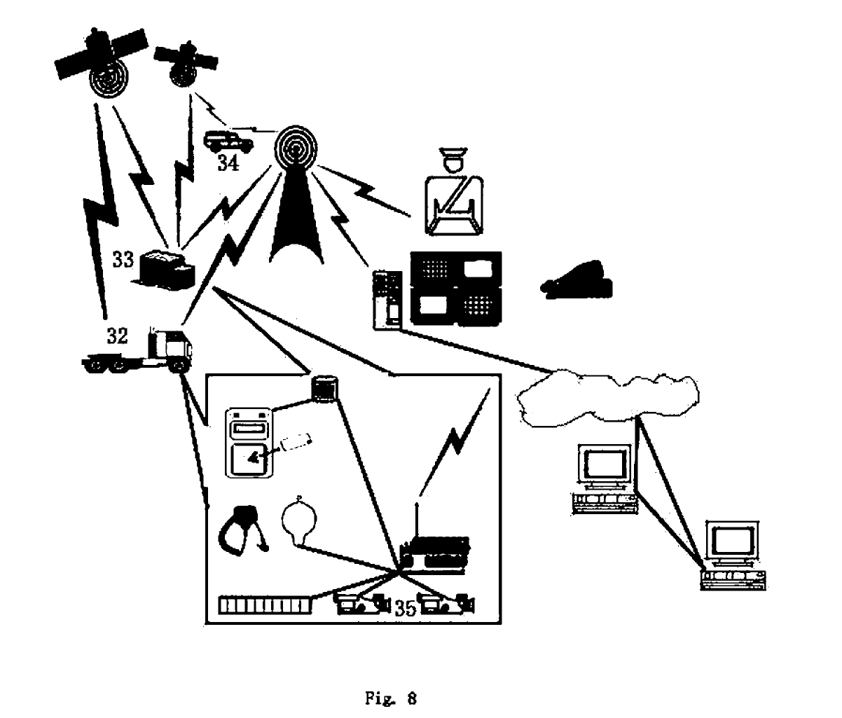

FIG. 8 shows another embodiment of the present invention. When this system being used on commercial transportation motorcade 32, finance security transportation motorcade for banks 33 or police patrol motorcade 34 etc situations, the application of IC card will transmit on-board time, place, the identification, total number etc information on specific persons inside of the vehicle to the information center or headquarter in real-time. The application of cameras etc CCTV equipment 35 inside and outside of the vehicle can also send video and/or audio information inside and outside of the vehicle to the information center or headquarter in real-time and being recorded into Hard-disk Recorder etc memory device. When theft, highjack or accident occurs, the information center or headquarter can also track the recorded information.

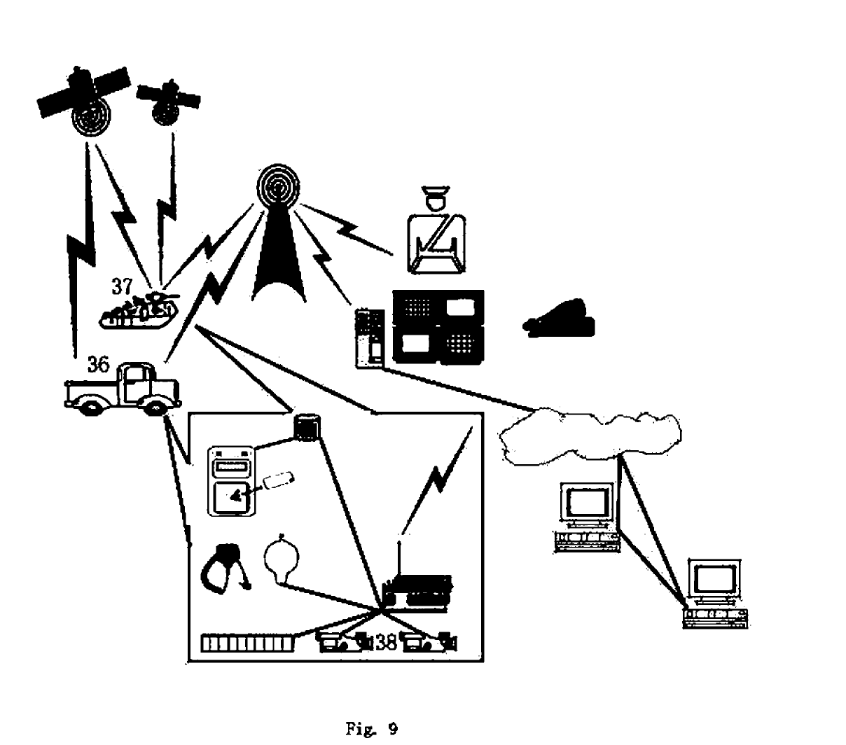

FIG. 9 shows the ninth embodiment of the present invention. When this system being used in military field, i.e., transportation motorcade 36 or tank motorcade 37, the application of IC card, which can be embedded in the soldiers' uniforms, can transmit on-board time, place, the identification, total number etc information on specific soldiers inside of the vehicle to the information center or headquarter in real-time. The application of cameras etc CCTV equipment 38 inside and outside of the vehicle can also send video and/or audio information inside and outside of the vehicle to the information center or headquarter in real-time. These accurate information during training or battle will help the information center to react in time.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. A real-time information collection supervising and allocating system for vehicle, comprising a wireless telecom network 3, wherein the system also includes a contact and/or contactless IC card 7 and card reader & writer 8 on vehicle 1. It can also include a signal converter 9, information and data reception and transmission device 10, computer servers 4 in the information center. The said signal converter 9 is used to convert the information read by IC card reader and writer 8 into digital or non-digital signal. The information and data reception and transmission device 10 here-of is used to transmit the above-mentioned digital or non-digital signals to the computer servers 4 in the information center via wireless telecom network 3 and being recorded into memory device.

2. A real-time information collection supervising and allocating system for vehicle as being defined in claim 1, wherein the system also includes display 5 that connects with the computer servers 4 in the information center. The display here-of includes but not limited to display screen wall. The vehicle 1 here-of includes but not limited to the following vehicles: public transportation vehicle, private transportation vehicle, finance security transportation motorcade for banks, commercial transportation motorcade, police patrol motorcade, military vehicle. The wireless telecom network 3 here-of includes but not limited to the following wireless telecom networks: mobile telecom network, radio telecom network, TV microwave telecom network, mobile telecom network that adopts Bluetooth technology and other wireless video transmission network.

3. A real-time information collection supervising and allocating system for vehicle as being defined in claim 1 and claim 2, wherein the system also includes GPS—Global Positioning System. It's used to obtain the one and only current position information of the vehicle 1 via satellite 2 and being transmitted to the computer server 4 in the information center via wireless telecom network 3.

4. A real-time information collection supervising and allocating system for vehicle as being defined in claim 1 and claim 2, wherein the system also includes CCTV monitoring equipment 13 to collect video and/or audio signals on the spot inside of the vehicle. The video and/or audio signals will be transmitted to the computer servers 4 in the information center via the information and data reception and transmission device 14 through wireless telecom network 3 and being recorded into memory device.

5. A real-time information collection supervising and allocating system for vehicle as being defined in claim 1 and claim 2, wherein the system also includes manual or foot-operated alarm device 18 being setup near the driver. In theft, highjack, traffic accident etc emergency situations, the driver can quietly touch the manual or foot-operated alarm device 18 to send the alarm information to the information center and/or police station via the information and data reception & transmission device 19.

6. A real-time information collection supervising and allocating system for vehicle as being defined in claim 1 and claim 2, wherein the system also includes allocating information transmitting device in the information center to transmit audio, video and/or text instructions to drivers via wireless telecom network to allocate the vehicle. It also includes speaker or text & video display device 21 near the driver, or VHF phones being setup separately on the driver's end 23 and the information center's end 22.

7. A real-time information collection supervising and allocating system for vehicle as being defined in claim 1 and claim 2, wherein the servers 4 in the information center here-of can be linked with Internet or intranet 25.

8. A real-time information collection supervising and allocating method for vehicle, comprising the steps of transmitting information via wireless telecom network, wherein identification and fare etc information inside of the contact or contactless IC card 7 in the vehicle 1 end, are read and written by IC card reader & writer 8. Signal containing above-mentioned information is converted by signal converter 9 into digital or non-digital signal. The information and data reception and transmission device 10 will transmit the above-mentioned digital or non-digital signals to the computer servers 4 in the information center via wireless telecom network 3 and being recorded into memory device.

9. A real-time information collection supervising and allocating method for vehicle as being defined in claim 8, wherein the GPS—Global Positioning System is being embedded or outlaid to the information & data reception & transmission device 10 to obtain the current one & only position information of the vehicle 1 via satellite 2. The location information is being transmitted to the computer servers 4 in the information center through wireless telecom network 3. Video and/or audio information collected by CCTV monitoring equipment 13 is transmitted to the computer servers 4 in the information center via the information & data reception & transmission device 10 through wireless telecom network and being recorded into memory device. The information being received by computer servers 4 in the information center is displayed on a display screen 5. When the manual or foot-operated alarm device 1 8 near the driver being touched, alarm information is transmitted to the information center and/or police station via the information & data reception and transmission device 10. The computer servers 4 here-of in the information center are being linked with users' terminals via internet or intranet 25.

10. A real-time information collection supervising and allocating method for vehicle as being defined in claim 8 and claim 9, wherein the allocating information transmission device in the information center will transmit audio, video or text instructions to the driver to allocate the vehicle via speaker and/or text and/or video display screen 21 near the driver through wireless telecom network. The other option is to transmit audio information via VHF phones 22 and 23.
